(19) United States
(12) Patent Application Publication
(10) Pub. No.: US 2010/0053791 A1
(43) Pub. Date: Mar. 4, 2010

(54) STORAGE DEVICE, RECORDING MEDIUM EVALUATION DEVICE, AND RECORDING MEDIUM EVALUATION METHOD

(75) Inventor: Kenrou Yamamoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki (JP)

(21) Appl. No.: 12/569,563

(22) Filed: Sep. 29, 2009

Related U.S. Application Data
(63) Continuation of application No. PCT/JP2007/058284, filed on Apr. 16, 2007.

(51) Int. Cl. G11B 27/36; G11B 21/02

(52) U.S. Cl. 360/31; 360/75; G9B/27.052; G9B/21.003

(57) ABSTRACT

According to one embodiment, a storage device that reads data from and writes data to a recording medium, which is rotationally driven by a motor, by a head, includes a ground disconnector, a motor voltage application module, and a Coulomb force detector. The ground disconnector disconnects a connection between the motor and ground. The motor voltage application module applies voltage to be supplied to the motor. The Coulomb force detector detects read output while the motor voltage application module applies voltage to the motor. The Coulomb force detector then calculates, based on the read output, an amount of change in floating height of the head to read data from or write data to the recording medium to detect the magnitude of Coulomb force generated by electrical charging of the recording medium based on the applied voltage and the amount of change in floating height of the head.

### CROSS-REFERENCE TO RELATED APPLICATIONS

This application is a continuation of PCT international application Ser. No. PCT/JP2007/058284 filed on Apr. 16, 2007 which designates the United States, incorporated herein by reference.

### BACKGROUND

1. Field

One embodiment of the invention relates to a storage device that writes/reads data by a head to/from a recording medium rotationally driven by a motor, a recording medium evaluation device, a recording medium evaluation method.

2. Description of the Related Art

A conventional magnetic disk device generally comprise a plurality of stacked recording media (magnetic disks) to be rotationally driven, a plurality of magnetic heads to be positioned over the recording media to record/reproduce data, and a plurality of actuator arms for rotationally moving the magnetic heads over the recording media. Each of the magnetic heads has a slider having a magnetic head element attached to one end thereof and a suspension for elastically supporting the slider. The magnetic heads fly over the high-speed rotating recording media at a height of several tens of nanometers due to slider's aerodynamic properties to record/reproduce data.

With a recent increase in the recording density of magnetic disk devices, the floating height of magnetic heads has been reduced to a minimum of 15 to 10 nm. However, when a magnetic disk of a magnetic disk device keeps rotating for a long period of time, there is a case where the magnetic disk is electrically charged by natural friction such as air friction, and as a result, Coulomb force, that is, an attractive or repulsive force is generated between the magnetic disk and a magnetic head. This changes the floating height of the magnetic head, thereby adversely affecting recording/reproduction of data to/from the magnetic disk as a recording medium. Under the circumstances, various technologies have been disclosed to control the floating height of a magnetic head of a magnetic disk device.

For example, Japanese Patent Application Publication (KOKAI) No. H9-91911 discloses a conventional technology for controlling the floating height of a head of a ramp load-type magnetic disk device. More specifically, a ramp load-type magnetic disk device moves a head when a magnetic disk device rotates at a normal speed so that the head is positioned over the magnetic disk. Then, when detecting that the head has been positioned over the magnetic disk, the magnetic disk device generates Coulomb force between the head and the magnetic disk to control the floating height of the head.

However, the conventional technology described above cannot detect Coulomb force generated by electrical charging of a recording medium. With the conventional technology, the floating height of a head is controlled by generating Coulomb force, and therefore cannot detect Coulomb force naturally generated by electrical charging of a recording medium. More specifically, the conventional technology cannot detect naturally-generated Coulomb force, and therefore, even when Coulomb force is generated to minimize the floating height of a head in order to achieve a higher recording density, the floating height of the head cannot be stably controlled because the head is influenced not only by Coulomb force generated between the head and a recording medium but also by naturally-generated Coulomb force. Therefore, the floating height of the head is not necessarily minimized.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram for explaining the outline and feature of a magnetic disk device according to a first embodiment of the invention;

FIG. 2 is an exemplary block diagram of the magnetic disk device in the first embodiment;

FIG. 3 is an exemplary diagram for explaining the calculation of the floating height of a head in the first embodiment;

FIG. 4 is an exemplary graph of applied voltage and the amount of change in floating height in the first embodiment;

FIG. 5 is an exemplary flowchart of Coulomb force detection performed by the magnetic disk device in the first embodiment; and

FIG. 6 is an exemplary block diagram of a magnetic disk device according to a second embodiment of the invention.

### DETAILED DESCRIPTION

Various embodiments according to the invention will be described hereinafter with reference to the accompanying drawings. In general, according to one embodiment of the invention, a storage device that reads data from and writes data to a recording medium, which is rotationally driven by a motor, by a head, comprises a ground disconnector, a motor voltage application module, and a Coulomb force detector. The ground disconnector is configured to disconnect a connection between the motor and ground. The motor voltage application module is configured to apply voltage to be supplied to the motor. The Coulomb force detector is configured to detect read output while the motor voltage application module applies voltage to the motor and calculate, based on the read output, an amount of change in floating height of the head to read data from or write data to the recording medium to detect magnitude of Coulomb force generated by electrical charging of the recording medium based on the voltage applied by the motor voltage application module and the amount of change in floating height of the head.

According to another embodiment of the invention, a recording medium evaluation device comprises a ground disconnector, a motor voltage application module, and a Coulomb force detector. The ground disconnector is configured to disconnect a connection between a motor and ground. The motor voltage application module is configured to apply voltage to be supplied to the motor. The Coulomb force detector is configured to detect read output while the motor voltage application module applies voltage to the motor and calculate, based on the read output, an amount of change in floating height of a head to read data from or write data to a recording medium to detect magnitude of Coulomb force generated by electrical charging of the recording medium based on the voltage applied by the motor voltage application module and the amount of change in floating height of the head.

According to still another embodiment of the invention, a recording medium evaluation method comprises: disconnecting a connection between a motor and ground; applying voltage to be supplied to the motor; and detecting read output while voltage is applied to the motor and calculating, based on the read output, an amount of change in floating height of a head to read data from or write data to a recording medium to detect magnitude of Coulomb force generated by electrical charging of the recording medium based on the voltage applied to the motor and the amount of change in floating height of the head.

A “magnetic disk device” according to a first embodiment of the invention is configured to rotationally drive a magnetic disk having a magnetic film by a spindle motor so that a magnetic head flies over the rotating magnetic disk at a height of several tens of nanometers to perform, for example, writing of data to the magnetic disk. In recent years, a higher recording density of magnetic disk devices has been achieved by reducing the floating height of magnetic heads to a minimum of 15 nm to 10 nm.

Therefore, it is necessary to control the floating height of the magnetic head of the “magnetic disk device” so that the floating height of the magnetic head is minimized. However, Coulomb force is naturally generated by electrical charging of the magnetic disk as a recording medium, and further, the magnitude of generated Coulomb force varies from magnetic disk to magnetic disk depending on their protective film such as Diamond Like Carbon (DLC) or lubricant. Therefore, even when the control of the floating height of the magnetic head is performed on each individual recording medium, the floating height of the magnetic head cannot be stably controlled due to the influence of Coulomb force. This makes it impossible to achieve a higher recording density of magnetic disk devices. In order to stably control the floating height of magnetic heads, it is important to detect the magnitude of generated Coulomb force varying from recording medium to recording medium.

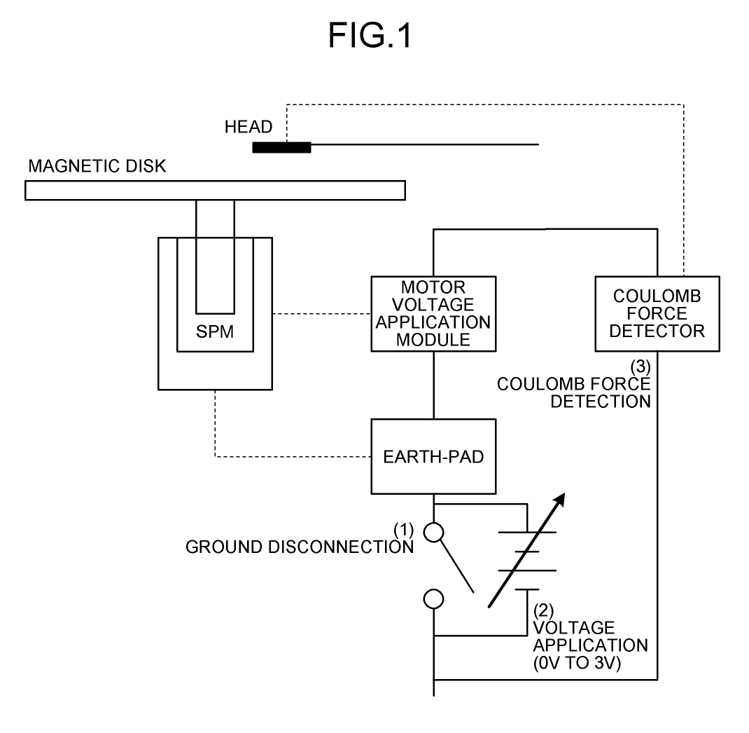

The outline and feature of a magnetic disk device according to the first embodiment will be described with reference to FIG. 1. FIG. 1 is a diagram for explaining the outline and feature of the magnetic disk device according to the first embodiment.

As illustrated in FIG. 1, the magnetic disk device of the first embodiment comprises a magnetic disk serving as a recording medium, a SPM (spindle motor) for rotationally driving the magnetic disk, and a head for performing writing/reading of data to/from the magnetic disk. The SPM is connected to ground through an Earth-pad to prevent the magnetic disk from being electrically charged. A motor voltage application module supplies a voltage required for the SPM to rotate.

As described above, the magnetic disk device configured as above writes/reads data by the head to/from the magnetic disk rotationally driven by the SPM. A salient feature of the magnetic disk device is that it can detect Coulomb force generated by electrical charging of a recording medium.

This salient feature of the magnetic disk device will be described more specifically. When receiving a signal for starting Coulomb force detection sent under the control of a user, the magnetic disk device disconnects the connection between the SPM and ground (see FIG. 1(1)).More specifically, when receiving a signal for starting Coulomb force detection sent under the control of a user, the magnetic disk device turns off a switch for connecting the Earth-pad to ground to disconnect the connection between the SPM and ground.

Then, the magnetic disk device applies a voltage to be supplied to the SPM (see FIG. 1(2)). More specifically, with reference to the above-described case, when the switch for connecting the Earth-pad to ground is turned off to disconnect the connection between the SPM and ground, the magnetic disk device applies a voltage increasing from 0 V to 3 V so that the motor voltage application module of the magnetic disk device supplies the applied voltage (increasing from 0 V to 3V) to the SPM.

Then, the magnetic disk device detects read output while the motor voltage application module supplies the applied voltage to the motor, and then calculates, based on the detected read output, the amount of change in the floating height of the head for writing/reading data to/from the magnetic disk to detect the magnitude of Coulomb force generated by electrical charging of the magnetic disk based on the applied voltage and the calculated amount of change in the floating height of the head (see FIG. 1(3)). More specifically, with reference to the above-described case, the magnetic disk device detects read output while the motor voltage application module supplies the applied voltage increasing from 0 V to 3 V to the motor, and then calculates, based on the detected read output, the amount of change in the floating height of the head for writing/reading data to/from the magnetic disk by the use of the Wallace equation to detect the magnitude of generated Coulomb force based on the applied voltage and the calculated amount of change in the floating height of the head.

For example, in a case where the calculated amount of change in the floating height of the head is as large as 2.5 nm under the condition that the applied voltage increases from 0 V to 3 V, the magnetic disk device can detect that the magnetic disk is likely to be electrically charged and the magnitude of generated Coulomb force is large. On the other hand, in a case where the calculated amount of change in the floating height of the head is as small as 0.1 nm under the condition that the applied voltage increases from 0 V to 3 V, the magnetic disk device can detect that the magnetic disk is less likely to be electrically charged and the magnitude of generated Coulomb force is small.

In this way, the magnetic disk device of the first embodiment can detect whether or not the magnetic disk is likely to be electrically charged. Therefore, as described above as the salient feature of the magnetic disk device, the magnetic disk device can detect the magnitude of Coulomb force generated by electrical charging of the magnetic disk as a recording medium.

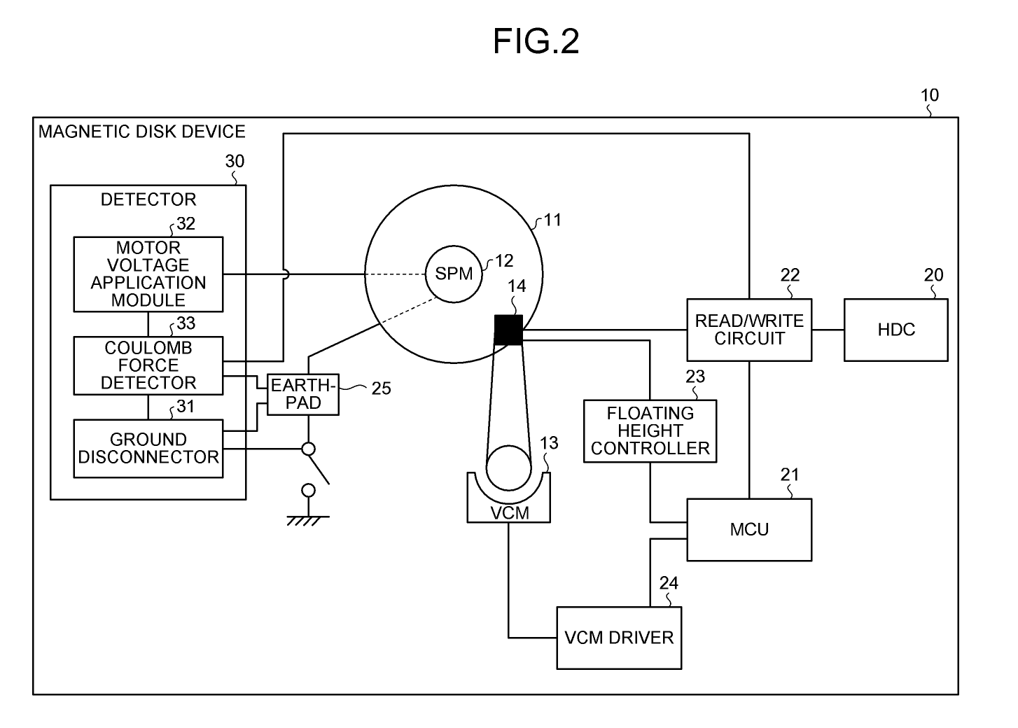

The configuration of the magnetic disk device illustrated in FIG. 1 will be described with reference to FIG. 2. FIG. 2 is a block diagram of a magnetic disk device 10 according to the first embodiment. As illustrated in FIG. 2, the magnetic disk device 10 comprises a magnetic disk 11, a SPM 12, a Voice Coil Motor (VCM) 13, a head 14, a Hard Disk Controller (HDC) 20, a Micro Control Unit (MCU) 21, a read/write circuit 22, a floating height controller 23, a VCM driver 24, an Earth-pad 25, and a detector 30.

The magnetic disk 11 is a recording medium for writing/reading data or servo information thereto/therefrom. More specifically, the magnetic disk 11 is rotationally driven by the spindle motor (SPM) 12, and the position of the head 14 is determined by the Voice Coil Motor (VCM) 13 (which will be described later) to write/read data to/from the magnetic disk 11.

The SPM 12 rotationally drives the magnetic disk 11. More specifically, the SPM 12 rotationally drives the magnetic disk 11 using electric power supplied by the magnetic disk device 10 (which will be described later), and supplies electric power (voltage) to the Earth-pad 25 (which will be described later) to prevent the magnetic disk 11 from being electrically charged.

The VCM 13 performs the positioning of the head 14 under the direction of the VCM driver 24 (which will be described later). More specifically, the VCM 13 is controlled by the VCM driver 24 to move the head 14 to a data write or read position on the magnetic disk 11.

The head 14 performs reading of servo information and reading/writing of data. More specifically, the position of the head 14 on the magnetic disk 11 is controlled by the VCM 13 to read servo information written on the magnetic disk 11 at a regular sampling period and to write/read data to/from the magnetic disk 11 in response to a data write or read request received from another terminal device connected to the magnetic disk device 10 at a data write or read position determined by the VCM 13.

The HDC 20 incorporates an interface to receive various commands sent from a host computer (not illustrated) connected thereto, and sends these commands to various functional modules. More specifically, for example, when receiving a control command from the SPM 12, the HDC 20 sends the command to the MCU 21 (described later), and when receiving a data write/read command, the HDC 20 directs the MCU 21 to control the position of the head 14 so that data is written/read to/from the magnetic disk 11 via the read/write circuit 22.

The MCU21 has an internal memory for storing programs defining various processing procedures and the like and required data, and directs various processing modules to perform processing. More specifically, for example, when receiving a command to control the SPM 12 from the HDC 20, the MCU 21 directs a current supply module (not illustrated) to supply an electric current required for rotationally driving the SPM 12, and when receiving a data write or read command, the MCU 21 directs the VCM driver 24 to move the head 14. Further, the MCU 21 directs the floating height controller 23 to supply a heater current to a heater (not illustrated) according to the magnitude of Coulomb force detected by a coulomb force detector 33 (which will be described later) to protrude the head 14 toward the magnetic disk to control the floating height of the head 14. It is to be noted that the floating height of the head 14 may be changed by, for example, a microactuator.

The read/write circuit 22 controls writing/reading of data to/from the magnetic disk 11. More specifically, the read/write circuit 22 has a modulation circuit for writing data to the magnetic disk 11 and a demodulation circuit for reading data from the magnetic disk 11.

The floating height controller 23 supplies a control current to the heater of the head 14. More specifically, when receiving a command to control the floating height of the head 14 from the MCU 21, the floating height controller 23 supplies a heater current to the heater to control the floating height of the head 14.

The VCM driver 24 sends various control requests for controlling the speed and position of the head 14 to the VCM 13. More specifically, the VCM driver 24 monitors the voltage of back electromotive force (speed signal) of the VCM 13, and supplies an electric current required for controlling the speed of the head 14 to the VCM 13. Even more specifically, the VCM driver 24 maintains the moving speed of the head 14 constant during unloading of the head 14. For example, in a case where the speed of the head 14 is reduced due to contact with a ramp, the VCM driver 24 increases the amount of electric current supplied to maintain the speed of the head constant so that the speed of the head 14 is increased.

The Earth-pad 25 is connected to ground to discharge electricity to prevent the magnetic disk 11 from being electrically charged. More specifically, the Earth-pad 25 receives, from the SPM 12, electricity generated by rotationally driving the magnetic disk 11, and discharges the electricity to ground to prevent the magnetic disk 11 from being electrically charged.

The detector 30 detects the magnitude of Coulomb force generated by electrical charging of the magnetic disk 11. The detector 30 includes a ground disconnector 31, a motor Voltage application module 32, and the Coulomb force detector 33.

The ground disconnector 31 disconnects the connection between the SPM 12 and ground. More specifically, the ground disconnector 31 turns off a switch for connecting the Earth-pad 25 to ground to disconnect the connection between the SPM 12 and ground so that electricity generated by rotationally driving the magnetic disk 11 sent from the SPM 12 to the Earth-pad 25 is not discharged to ground.

The motor voltage application module 32 applies a voltage to be supplied to the SPM 12. More specifically, when the switch for connecting the Earth-pad 25 to ground is turned off by the ground disconnector 31 to disconnect the connection between the SPM 12 and ground, the motor voltage application module 32 applies a voltage to be supplied to the SMP 12. For example, when the switch for connecting the Earth-pad 25 to ground is turned off by the ground disconnector 31 to disconnect the connection between the SPM 12 and ground, the motor voltage application module 32 supplies an applied voltage increasing from 0 V to 3 V to the SPM 12. It is to be noted that in this case, the applied voltage increases from 0 V to 3 V, but this is not intended to limit the value of the applied voltage. For example, the applied voltage may increase from 0 V to 5 V.

The Coulomb force detector 33 detects read output while the motor voltage application module 32 applies a voltage to the motor, and then calculates, based on the detected read output, the amount of change in the floating height of the head for writing/reading data to/from the magnetic disk 11 to detect the magnitude of Coulomb force generated by electrical charging of the magnetic disk 11 based on the applied voltage and the calculated amount of change in the floating height of the head. More specifically, with reference to the above-described case, the Coulomb force detector 33 reads data from the magnetic disk 11 in a state where the motor voltage application module 32 applies a predetermined voltage to the motor, and then calculates the amount of change in the floating height of the head 14 based on the read output (data reproduction signal) to detect the magnitude of Coulomb force generated by electrical charging of the magnetic disk 11 based on the calculated amount of change in the floating height of the head 14.

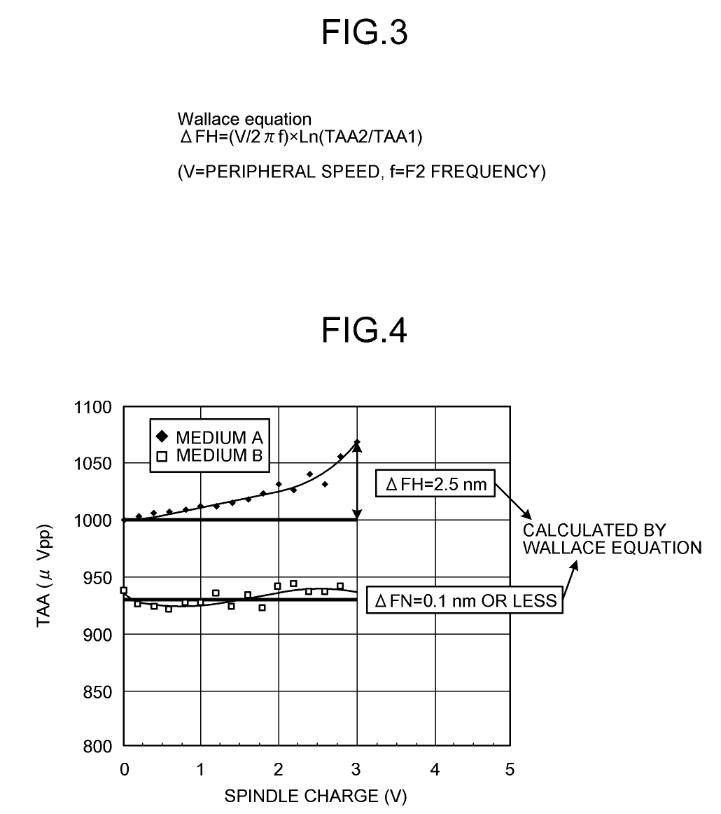

Hereinbelow, one example of a method for calculating the amount of change in floating height (FH) will be described. As illustrated in FIG. 3, when read output produced when a voltage applied to the spindle motor is “0 V” (steady state) is defined as “TAA1” and read output produced when a voltage applied to the spindle motor is “1 V” is defined as “TAA2”, the floating height (FH) of the head during a steady state is previously measured by a floating height measuring instrument, and ΔFH is calculated as the amount of change in floating height. The amount of change in floating height can also be calculated based on the fact that the amount of change in reproduction amplitude derived from the Wallace spacing loss equation varies depending on the floating height.

As illustrated in FIG. 4, in a case where the calculated amount of change in floating height is as large as 2.5 nm under the condition that a voltage applied by the motor voltage application module 32 increases from 0 V to 3 V, the Coulomb force detector 33 detects that a recording medium A illustrated in FIG. 4 is likely to be electrically charged and the magnitude of generated Coulomb force is large. On the other hand, in a case where the calculated amount of change in floating height is as small as 0.1 nm under the condition that a voltage applied by the motor voltage application module 32 increases from 0 V to 3 V, the Coulomb force detector 33 detects that a recording medium B illustrated in FIG. 4 is less likely to be electrically charged and the magnitude of generated Coulomb force is small. It is to be noted that FIG. 4 is a graph of applied voltage and the amount of change in floating height.

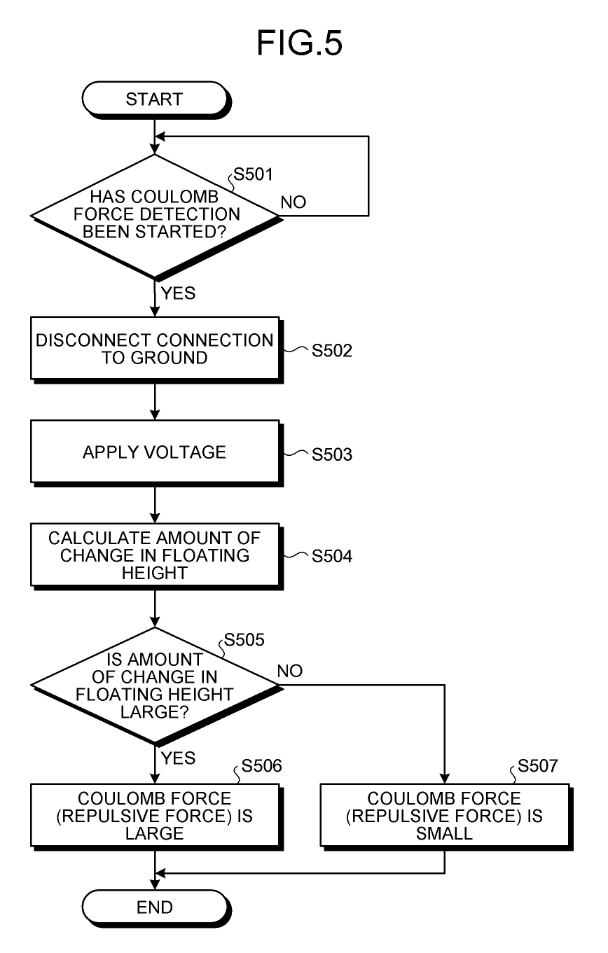

The operation of the magnetic disk device will be described with reference to FIG. 5. FIG. 5 is a flowchart of Coulomb force detection performed by the magnetic disk device according to the first embodiment.

As illustrated in FIG. 5, when the magnetic disk device receives a command to start Coulomb force detection sent under the control of a user (i.e., when the answer to S501 is YES), the ground disconnector 31 of the magnetic disk device 10 disconnects the connection between the SPM 12 and ground (S502).

Then, the motor voltage application module 32 applies a voltage to be supplied to the SPM 12 (S503), and the Coulomb force detector 33 detects read output while a voltage is applied to the motor, and then calculates, based on the detected read output, the amount of change in the floating height of the head 14 for writing/reading data to/from the magnetic disk 11 (S504).

Then, the Coulomb force detector 33 judges whether or not the calculated amount of change in floating height is large (S505).

When the calculated amount of change in floating height is large (i.e., when the answer to S505 is YES), the Coulomb force detector 33 detects that the magnetic disk 11 is likely to be electrically charged and the magnitude of generated Coulomb force is large (S506).

On the other hand, when the calculated amount of change in floating height is small (i.e., when the answer to S505 is NO), the Coulomb force detector 33 detects that the magnetic disk 11 is less likely to be electrically charged and the magnitude of generated Coulomb force is small (S507).

As described above, according to the first embodiment, the connection between the SPM and ground is disconnected and a voltage to be supplied to the SPM is applied. The amount of change in the floating height of the head for writing/reading data to/from the magnetic disk is calculated based on the voltage supplied to the SPM. The magnitude of Coulomb force generated by electrical charging of the magnetic disk is detected based on the applied voltage and the calculated amount of change in the floating height of the head. In this manner, it is possible to detect Coulomb force generated by electrical charging of a recording medium.

For example, in the case where the amount of change in the floating height of the head is small under the condition that the output voltage to the SPM is large, it can be detected that Coulomb force as an attractive force is large, and in a case where the amount of change in the floating height of the head is large in spite of the fact that the output voltage to the SPM is small, it can be detected that Coulomb force as a repulsive force is large.

Moreover, it is possible to previously detect a recording medium less likely to generate Coulomb force. By using such a recording medium, it is possible to provide a highly-reliable magnetic disk device capable of stably controlling the floating height of a head.

While, in the first embodiment, only the case is described where the magnitude of Coulomb force generated by electrical charging of the magnetic disk is detected, it is not so limited. For example, the detected magnitude of Coulomb force may be used to control the floating height of the head.

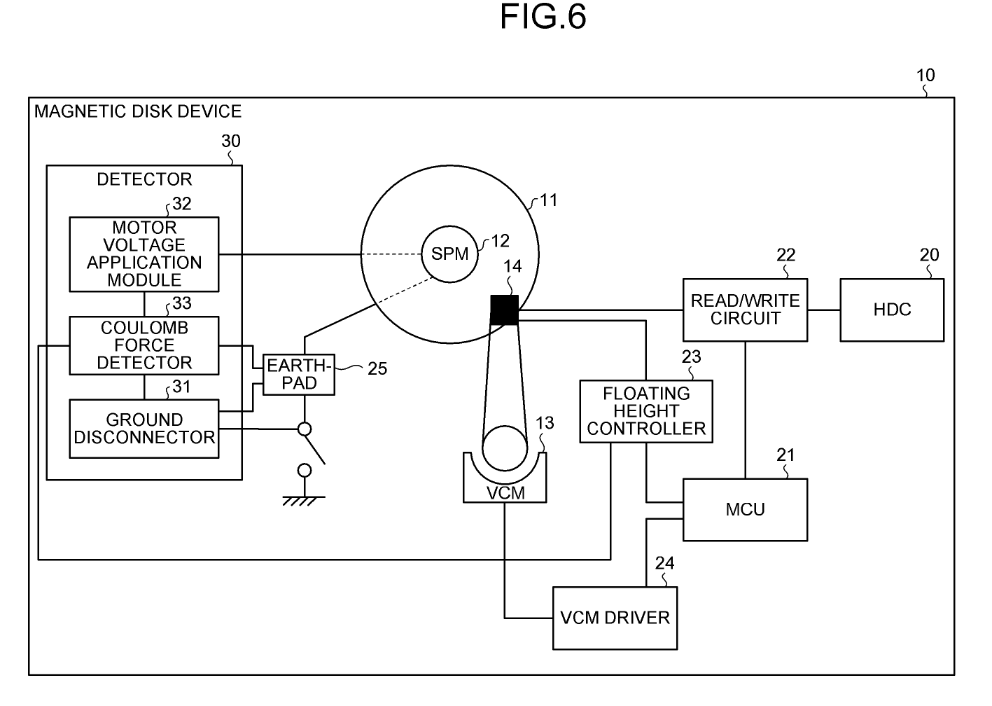

Referring to FIG. 6, a second embodiment of the invention will be described, in which the magnitude of Coulomb force generated by electrical charging of a magnetic disk is detected and the floating height of a head is controlled based on the detected magnitude of Coulomb force. FIG. 6 is a block diagram of a magnetic disk device according to the second embodiment.

The magnetic disk device 10 comprises the magnetic disk 11, the SPM 12, the VCM 13, the head 14, the HDC 20, the MCU 21, the read/write circuit 22, the floating height controller 23, the VCM driver 24, the Earth-pad 25, and the detector 30 having the ground disconnector 31, the motor voltage application module 32, and the Coulomb force detector 33. It is to be noted that the magnetic disk 11, the SPM 12, the VCM 13, the head 14, the HDC 20, the MCU 21, the read/write circuit 22, the VCM driver 24, the Earth-pad 25, and the detector 30 having the ground disconnector 31 and the motor voltage application module 32 of the detector 33 have the same functions as those of the magnetic disk device of the first embodiment, and therefore, their description will not be repeated. The floating height controller 23 and the Coulomb force detector 33 having functions different from those described in the first embodiment will be described below.

The floating height controller 23 supplies a heater current according to the magnitude of Coulomb force detected by the Coulomb force detector 33 (which will be described later) to control the floating height of the head 14. More specifically, for example, in a case where the floating height controller 23 receives a signal indicating that the previously-detected magnitude of Coulomb force is large from the Coulomb force detector 33, the amount of heater current to be supplied to the head 14 is increased to reduce the floating height of the head 14, and on the other hand, in a case where the floating height controller 23 receives a signal indicating that the previously-detected magnitude of Coulomb force is small from the Coulomb force detector 33, the amount of heater current to be supplied to the head 14 is reduced because it is not necessary to reduce the floating height of the head 14.

The Coulomb force detector 33 has, in addition to the function described above in the first embodiment, the function of outputting, as a parameter for controlling the floating height of the head 14, a signal indicating the previously-detected magnitude of Coulomb force stored in a storage module such as a memory to the floating height controller 23 when the magnetic disk device 10 is used. More specifically, for example, in a case where the magnitude of Coulomb force generated by electrical charging of the magnetic disk 11 previously detected by the Coulomb force detector 33 is large, the Coulomb force detector 33 outputs a signal indicating that the previously-detected magnitude of Coulomb force is large to the floating height controller 23, and in a case where the magnitude of Coulomb force generated by electrical charging of the magnetic disk 11 previously detected by the Coulomb force detector 33 is small, the Coulomb force detector 33 outputs a signal indicating that the previously-detected magnitude of Coulomb force is small to the floating height controller 23.

As described above, according to the second embodiment, a voltage to be supplied to the head 14 is increased when the previously-detected magnitude of Coulomb force is large, and is decreased when the previously-detected magnitude of Coulomb force is small. In this manner, it is possible to accurately control the floating height of the head 14.

More specifically, the magnitude of Coulomb force generated by electrical charging of a recording medium is previously detected and stored in a storage module such as a memory, and therefore when the magnetic disk device 10 is used, an electric current to be supplied to the heater can be controlled in consideration of the previously-detected magnitude of Coulomb force. For example, in a case where detected Coulomb force is a strong attractive force, the amount of heater current to be supplied to the heater is decreased, and in a case where detected Coulomb force is a strong repulsive force, the amount of heater current to be supplied to the heater is increased. By doing so, it is possible to accurately control the floating height of the head 14 to achieve the floating height of the head 14 appropriate to each individual recording medium. It is to be noted that the second embodiment has been described with reference to a case where the head 14 has, in addition to a write head element and a read head element, a heater mounted on a head slider. However, the head 14 does not always need to have a heater, and the floating height of the head 14 may be controlled by utilizing the heat generation of a coil of the write head element. Alternatively, the floating height of the head 14 may be controlled using a microactuator.

While specific embodiments have been described, other embodiments or modifications are also possible. In the following, such modifications will be described

(1) Recording Medium Evaluation Device (Disk Tester)

While the first and second embodiments are described by way of example as being applied to a magnetic disk device, it is not so limited. For example, the first and second embodiments may be applied to a recording medium evaluation device that detects the magnetic characteristics of a recording medium based on a voltage supplied from a motor for rotationally driving a magnetic disk to ground.

(2) System Configuration, Etc.

The constituent elements described above are functionally conceptual, and need not be physically configured as illustrated. In other words, the specific mode of dispersion and integration of the constituent elements is not limited to the one illustrated in the drawings, and the constituent elements, as a whole or in part, can be divided or integrated either functionally or physically based on various types of loads or use conditions (e.g., the motor voltage application module and the ground disconnector may be integrated with each other). Further, all or arbitrary part of the process functions performed by each device can be implemented by a central processing unit (CPU) and a computer program analyzed and executed by that CPU, or can be implemented as hardware by wired logic.

Of the processes described above, all or part of the processes described as being performed automatically (e.g., head position control) may be performed manually, or all or part of the processes described as being performed manually (e.g., insertion of a magnetic disk into a magnetic disk device) may be performed automatically with a known method. The process procedure, the control procedure, specific names, and information including various data and parameters described above and illustrated in the drawings (e.g., FIG. 2) can be arbitrarily changed unless otherwise specified.

(3) Program

The detection of Coulomb force by the magnetic disk device described in the first and second embodiments may be realized by executing a computer program on a computer (e.g., the MCU 21 of the magnetic disk device 10). The computer program may be distributed through a network such the Internet. The computer program may also be stored in a computer-readable storage medium, such as compact disc-read only memory (CD-ROM), magnetic optical disk (MO), and digital versatile disk (DVD), and read from the medium and executed by the computer.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device that reads data from and writes data to a recording medium, which is rotationally driven by a motor, by a head, the storage device comprising:
a ground disconnector configured to disconnect a connection between the motor and ground;
a motor voltage application module configured to apply voltage to be supplied to the motor; and
a Coulomb force detector configured to detect read output while the motor voltage application module applies voltage to the motor and calculate, based on the read output, an amount of change in floating height of the head to read data from or write data to the recording medium to detect magnitude of Coulomb force generated by electrical charging of the recording medium based on the voltage applied by the motor voltage application module and the amount of change in floating height of the head.

2. The storage device according to claim 1, further comprising a head supply voltage controller configured to control the floating height of the head, wherein
when the magnitude of Coulomb force detected by the Coulomb force detector is large, the head supply voltage controller increases electric current to be supplied to the head, and
when the magnitude of Coulomb force detected by the Coulomb force detector is small, the head supply voltage controller reduces electric current to be supplied to the head.

3. The storage device according to claim 2, wherein the head supply voltage controller is configured to control the floating height of the head according to the magnitude of Coulomb force detected by the Coulomb force detector previously stored in a predetermined storage module.

4. A recording medium evaluation device, comprising:
a ground disconnector configured to disconnect a connection between a motor and ground;
a motor voltage application module configured to apply voltage to be supplied to the motor; and
a Coulomb force detector configured to detect read output while the motor voltage application module applies voltage to the motor and calculate, based on the read output, an amount of change in floating height of a head to read data from or write data to a recording medium to detect magnitude of Coulomb force generated by electrical charging of the recording medium based on the voltage applied by the motor voltage application module and the amount of change in floating height of the head.

5. A recording medium evaluation method, comprising:
disconnecting a connection between a motor and ground;
applying voltage to be supplied to the motor; and
detecting read output while voltage is applied to the motor and calculating, based on the read output, an amount of change in floating height of a head to read data from or write data to a recording medium to detect magnitude of Coulomb force generated by electrical charging of the recording medium based on the voltage applied to the motor and the amount of change in floating height of the head.

6. The recording medium evaluation method according to claim 5, further comprising controlling voltage to be supplied to the head, wherein
when the magnitude of Coulomb force is large, voltage to be supplied to the head is increased, and
when the magnitude of Coulomb force is small, voltage to be supplied to the head is reduced.

7. A computer program product embodied on a computer-readable medium and comprising code for recording medium evaluation, the code, when executed, causing a computer to perform:
disconnecting a connection between a motor and ground;
applying voltage to be supplied to the motor; and
detecting read output while voltage is applied to the motor and calculating, based on the read output, an amount of change in floating height of a head to read data from or write data to a recording medium to detect magnitude of Coulomb force generated by electrical charging of the recording medium based on the voltage applied to the motor and the amount of change in floating height of the head.
